(19) United States
(12) Patent Application Publication
(10) Pub. No.: US 2011/0106608 A1
(43) Pub. Date: May 5, 2011

(54) Electronic coupon generation, distribution, reimbursement and settlement system

(76) Inventor: Gabriel B. Rothberg, Los Angeles, CA (US)

(21) Appl. No.: 12/590,254

(22) Filed: Nov. 5, 2009

(51) Int. Cl. G06Q 10/00; G06Q 30/00

(52) U.S. Cl. 705/14.26; 705/14.38; 705/304

(57) ABSTRACT

The Electronic Coupon Generation, Distribution, Reimbursement and Settlement System is a fully integrated system that is designed to coexist with paper based coupon systems and Internet sites that generate paper coupons and as warranted replace these coupon systems.

The system is intended to be used by consumers who enroll and become active members and their representatives who initiate qualified shopping sessions at system supported point-of-sales sites.

A proprietary database management enables manufacturers (or product controllers) to provide formatted information used by the system to generate electronic coupons and distribute them to consumers at point-of-sale sites controlled by participating merchandisers located throughout the country. The system supports the immediate reimbursement of consumers and reflects the coupons generated and reimbursement earnings on the register tape for a qualified shopping trip. The system also supports all settlement between manufacturers and merchandisers and the collection of service fees related to the electronic coupons generated.

Coupon transaction history is collected for monitoring and audit purposes and appropriately selectively shared with manufacturers and merchandisers. The system uses the Internet and established secure sites to support communications and provide information and planning tools to consumers, manufacturers and merchandisers using the system. All processing, data storage and data transmissions is performed in compliance with the highly regarded data security standards established by the Payment Card Industry (PCI) for handling sensitive user information involving debit/credit card and financial transaction processing.

### CROSS-REFERENCE TO RELATED APPLICATIONS

This is a new nonprovisional utility patent application. There is no relationship to, any other provisional or nonprovisional patent applications.

### STATEMENT REGARDING FEDERALLY SPONSORED RESEARCH OR DEVELOPMENT

Not applicable since there was no federally sponsored research or development.

### REFERENCE TO A SEQUENCE LISTING, A TABLE OR A COMPUTER PROGRAM LISTING APPENDIX

Not applicable, no sequence listing, table or a computer program listing appendix submitted.

### BACKGROUND OF THE INVENTION

During the present recessionary period many consumers are looking for ways to save money. One popular means of saving money is through the use of manufacturer provided coupons.

Present coupon generation, distribution, reimbursement and settlement processes are very inefficient. They require that issuers spend considerable money to generate and distribute the coupons and for consumers to perform tedious and time-consuming activities including clipping, collecting, organizing, managing and presenting coupons for reimbursement. Once coupons are presented there is a tedious process for merchandisers to present coupons for reimbursement from the manufactures who issued them. Aspects of the generation process are somewhat improved through the advent of computer sites that enable consumers to select and print coupons they desire from these Internet sites.

In summary, while coupons are quite popular there is much inefficiency in the present generation, distribution, reimbursement and settlement processes. Additionally, the current processes are prone to fraud since they involve many disparate steps in the process which can result in coupons being presented for reimbursement without having fulfilled the purchase requirements specified.

### BRIEF SUMMARY OF THE INVENTION

The Electronic Coupon Generation, Distribution, Reimbursement and Settlement System is a fully integrated system using data base management, cloud computing, state-of-the-art security provisions associated with debit/credit payment card processing, and electronic funds transfer processes. This system can coexist with current paper coupon and Internet coupon printing schemes and as warranted replace the current systems. The Electronic Coupon Generation, Distribution, Reimbursement and Settlement System offers advantages and benefits to manufacturers (or other primary product controllers), merchandisers (who control the point of sale sites) and consumers. This process also may provide a new income stream for debit/credit card issuers. Specific advantages include the following:
1. Manufacturers will be able to issue electronic coupons and save graphic design preparation, printing and publishing/placement costs.
2. Faster turnaround in the issuance process and more timely and comprehensive distribution results by geographical area will enable manufacturers to use coupons more effectively to support both strategic and tactical sales strategies.
3. Consumers will be able to enjoy the benefit of coupons without committing time to the collection, clipping, organizing and management processes. At their option they will be able to increase their coupon benefits by preplanning trips to the market and maximizing use of available coupons by first studying information on an Internet site showing manufacturers coupons available by product category and date in their geographical area.
4. Merchandisers will be reimbursed daily for coupons processed at their point of sales sites since the coupon value and any associated service fees will be charged to the manufacturer and collected daily
5. Merchandisers will be relieved of the tedious review, validation, acceptance and presentment for reimbursement processes required for present paper coupons.
6. Coupon usage information will be collected by point-of-sale site by product and can be made available for analysis by manufacturers and merchandisers to aid sales and procurement decisions.
7. Timely feedback heightens the potential for using coupons to adjust product prices to increase sales in geographical locations where there is a surplus of product on hand, to support targeted marketing campaigns and to expediently adjust coupon values when needed to influence product sales demand.
8. The direct linkage of electronic coupons to the underlying point-of-sale transactions eliminates fraudulent activities such as the production and presentment of counterfeit coupons, the processing of expired coupons and the redemption of coupons where consumer purchasing requirements are not met.
9. The system uses existing SKU product identification to support the coupon generation process so there is no need to introduce new coding schemes.
10. Consumers will switch to this more effective and less costly alternative to obtaining product coupons and gravitate to shopping at point-of-sale sites that support the Electronic Coupon Generation, Distribution, Reimbursement and Settlement System.

### BRIEF DESCRIPTION OF THE SEVERAL VIEWS OF THE DRAWING

Not applicable, there are no drawings submitted.

### DETAILED DESCRIPTION OF THE INVENTION

The focal point of the Electronic Coupon Generation, Distribution, Reimbursement and Settlement System is the supporting central database management system. Components of this system provide coupon information to consumers at an Internet site available nationally. This same database management system has components supporting the point-of-sale coupon generation, distribution, reimbursement and settlement processes triggered at the time of purchase. The same database management system maintains a history of coupon issuance and redemption activities and all associated funds transfers. This information is used for monitoring and audit review purposes as well as providing manufacturers and merchandisers with information needed to evaluate the program and fine tune plans for effective future coupon use.

Key database components include the following:

Product Master—Contains the product identifiers and descriptive information required for coupon issuance. The product keys are those currently assigned by the manufacturers and used by point-of-sale systems to record product sales. All products are assigned to a manufacturer (primary controller of the product) and to a product category. The product master stores a suggested product sales price which can be used to edit the maintenance process when maintaining the Electronic Coupon Template records described below.

Product Categories Master—This file contains a master record for each product category. Each product must be assigned to a valid category. Products are organized by category to facilitate planning by consumers when accessing the Internet site to determine available coupons.

Manufacturers Master—Every. Manufacturer must have a valid master file record before any products can be associated with the manufacturer and product related coupon templates established. The Manufacturer or primary controller of a product is the only one who can issue product coupons at this time. In the future the system can be expanded to enable merchandisers or other supply chain organizations to use the system to issue product coupons. This component also contains address and contact information for the Manufacturer, their current deposit balance available to cover coupons issued and the bank account to be charged for coupons issued and any related service fees.

Manufacturers Administrator Master—This component is used to establish a master record for all users who can maintain a Manufacturer's coupon template information used in the generation of electronic coupons for the Manufacturer's products.

Merchandisers Master—Every Merchandiser supporting point-of-sale sites where coupons are generated must have a valid master file record before any point-of-sale sites for coupon generation can be established. This file will indicate the bank account where any service fees related to the coupon generation process will be deposited.

Merchandiser Administrator Master—This component is used to establish a master record for all users who can maintain a Merchandiser's site records.

Merchandiser Point-of-Sale Site Master—This component is used to establish a record for every point-of-sale site owned by a merchandiser that will be used to generate electronic coupons. Each site is assigned to a zip code and it is noted whether electronic coupons generated at the site can be doubled or tripled and under what limitations.

Electronic Coupon Template—A record on this database component pertains to a specific product and specifies the value of the electronic coupon to be generated, the number of products required to be purchased for a coupon to be generated and the maximum number of identical coupons to be generated for a single consumer trip to the market (register receipt). Most importantly, an electronic coupon component can be restricted to one or a range of zip codes (geographical designation) and restricted to a specific date range (time designation). This file has an active segment for records which are still current and being used in the generation of records on the Daily Electronic Coupon file described below and a historical component for records no longer used in preparing records for the Daily Electronic Coupon file. Records on this file cannot be altered for any date once they are used for generating records on the Daily Electronic Coupon file. Records can be altered impacting the coupon generation process for future dates where the Daily Electronic Coupon file preparation process has yet to be performed.

Daily Electronic Coupon file—This file is generated daily using the Electronic Coupon Template records stored in the current segment and applicable to the Daily Electronic Coupon file being created. The daily coupon file is arbitrarily created seven days in advance of a particular date so it can be made available on the Internet site to support a consumer shopping trip and coupon redemption planning (the seven day lead time is an arbitrary period that can be changed). This file is also used daily to refresh the point-of-sales sites with information required to generate coupons. Only records pertaining to the zip code where a point-of-sale site is located are sent to a particular site for use in the electronic coupon generation process.

Consumer Master—Every consumer participating in the program must first enroll and establish a valid master record. Aside from general name and demographic information, the consumer must supply a valid debit or credit card to be used for identification and to activate the coupon generation process. The consumer must also supply a phone number to be used to activate the electronic coupon generation process in lieu of providing a debit/credit card to be scanned. The use of a phone number will enable other family members to initiate the coupon generation process. As explained in the section below in regards to the Daily Electronic Coupon Transaction File all activity is monitored to detect unusual transactions. It will be possible to flag the consumer master and prevent coupon generation activity if abuses are detected. A consumer who has an active consumer master record indicating membership can also activate the electronic coupon generation process for a point-of-sales site controlled by a particular merchandiser in conjunction with being recognized as a member in the merchandiser's loyalty program (this is usually accomplished by providing a loyalty card or phone number recorded for the loyalty program member on the merchandiser's system) where the merchandiser system in turn identifies the consumer's membership record in the coupon generation system and triggers the activation of the coupon generation system for the shopping trip.

Daily Electronic Coupon Transaction File—This file contains the daily electronic coupons generated for a consumer for each shopping trip (register receipt). A record on this file includes the consumer member identifier, the product identifier, the product manufacturer identifier, the merchandiser identifier, the point-of-sale site identifier, the coupon value, the service fee value and a date/time stamp (trip identifier). For sites where coupon doubling or tripling is indicated the record also contains the value earned by the consumer for doubling/tripling which is charged back to the merchandiser.

The system is designed to provide immediate gratification to the consumer when they complete their shopping trip and leave the point-of-sale site. The consumer is immediately compensated for all coupon earnings associated with their shopping trip. As part of the closing processing performed each day the information on this file is used to generate reimbursements to merchandisers, fee payments to merchandisers and the system administrator and charges to manufacturers for their generated coupons and associated service fees. Daily, this information is consolidated into history files to support monitoring and analysis by manufacturers and merchants of information relevant to them. The information collected on this file can be used to monitor consumer activity to detect any inordinate use or abuse and can be used to restrict consumer trip activity if desired.

Daily Financial Transaction File—During the end of day processing the transactions on the Daily Electronic Coupon Transaction File are used to generate financial transactions to settle coupon generation activity for the day with manufacturers and merchandisers. This process creates the day's recap of reimbursements to consumers (already paid by the merchandiser at the point-of-sale site), reimbursement for coupon payment and service fee payments to merchandisers and the system administrator and associated charges to manufacturers. Rules can be applied to deal with situations where a manufacturer does not have sufficient funds in their disbursement account to cover charges for the day (should not occur since manufacturers must maintain a suitable deposit balance in accordance with their participation agreement). All financial transactions are posted and accumulated in a history file for monitoring and subsequent review.

Key Processing Procedures

The Product Categories Master is established at the outset and expanded/modified as needed. These categories are universal and used by all manufacturers entering products to the Product Master.

Each Manufacturer must be established on the Manufacturer Master File and Manufacturer Administrators established on the Manufacturer Administrator File. The Manufacturer completes Product Records on the Product File for all products for which electronic coupons will be offered. Each Product is linked to a Manufacturer (controlling organization) and a product category.

Each Merchandiser must be established on the Merchandiser Master File and Merchandiser Administrators established on the Merchandiser Administrator File. The Merchandiser completes a Point-of-Sale Site record for each point-of-sale site the merchandiser controls. All point-of-sales sites are linked to a merchandiser and a zip code (geographical location).

Once manufacturers and merchandisers are established the key ongoing processing involves manufacturers updating the Electronic Coupon Templates. These Electronic Coupon Template records are used by the system to generate the Daily Electronic Coupon File. The Daily Electronic Coupon File contains records made available to point-of-sales sites throughout the country (the subset relevant to their zip code) which are used to produce electronic coupons for consumers meeting product purchase requirements during qualified shopping sessions.

Manufacturers are provided with timely transaction information by the system needed to plan their continued use of electronic coupons to achieve advertising, promotion and sales goals.

Merchandisers are provided with timely transaction information needed to plan their coupon doubling and tripling strategies and related advertising programs.

Most importantly, consumers are provided an opportunity to proactively take advantage of electronic coupon offers available at the point-of-sales site they visit. To take advantage of the electronic coupon system a consumer must have enrolled and established an active member account and when visiting the point-of-sale site the consumer or their representative must authenticate their membership by supplying a credit/debit card or suitable information for validation their qualification for receiving electronic coupons such as a phone number on file. The more shopping trip planning performed by the consumer the more likely they will purchase items that initiate the coupon generation process. However even without much planning and upfront effort prior to their trip to the market, consumers may complete the authentication process at the point-of-sale site and still benefit from the program by purchasing items that a manufacturer coincidently wishes to promote. Merchandisers may provide advertisements and signage to aid in the identification of items having associated electronic coupons that day.

Aside from shopping trips using point-of-sale sites, it is anticipated that all consumer interaction with the Electronic Coupon Generation, Distribution, Redemption and Settlement system will take place over the Internet by accessing the Internet site and logging on to their account. The site can also be used to apprise consumers of coupons they might be particularly interested in based on their past buying patterns when accessed. This feature would further encourage consumers to use the system. As noted, consumers can access the Internet site to plan future shopping trips and maximize their advantage from the electronic coupon generation process. When a consumer logs on they will be presented with a subset of coupon information relevant to their zip code unless they override their normal zip code and seek information for another zip code location (when traveling or on vacation etc.). Consumers can also query the system to search for point-of-sale sites supporting the system located in their zip code area or another specified zip code area. Consumers can also access the Internet site to view recent history showing reimbursements received for shopping trips completed within a specific timeframe (consider limiting this feature to the current month's activity, current quarter or current year and whether individual coupons are listed or just register recap redemption totals). This historical information should confirm to them the financial value of their participation in the electronic coupon generation program.

The primary transaction processing takes place immediately at the point-of sale site resulting in coupons being generated and coupon transactions posted to the Daily Electronic Coupon File. The other key set of transactions is generated during the daily settlement process that takes place at the end of the day where all financial transactions are generated, processed and posted to the Daily Financial Transaction File. As noted above, an important feature of the system is its ability to provide immediate consumer gratification by generating and distributing coupons to the consumer and reimbursing the consumer at the point-of-sale site reflecting the results on their register tape. Settlements with merchandisers, the system administrator and manufacturers are completed at the end of the day with all activity recorded and saved in the Daily Electronic Coupon Transaction File and the Daily Financial Transaction File. This history is consolidated with other daily activity to support manufacturer and merchandiser review and analysis of their transaction activity.

Security

Since the system utilizes sensitive consumer information it is critical that appropriate access controls be maintained so information is not compromised or falls into unauthorized hands. Therefore, cloud computing processes put in place and all electronic information transfers between point-of-sale sites and the central system should be protected by controls required by the Payment Card Industry (PCI) as dictated by their data security standards. It is anticipated that all point-of-sale sites to be supported by this system are already subjected to this control standard.

All master file updates processed within the Electronic Coupon Generation, Distribution, Reimbursement and Settlement System will be time stamped and note the user performing the update. All generated coupons will identify the time and site where they were generated and the consumer receiving the reimbursement.

Detailed transaction data is collected and monitored by product, manufacturer, consumer and site to detect any unusual processing or failures to comply with electronic coupon template rules in effect for a particular date and geographical location. This history can also be used to investigate and resolve any subsequent consumer complaints regarding reimbursements received.

1. I claim as my invention the use of a proprietary integrated database management system maintained using state-of-the-art computing technology to support all processing procedures performed by the Electronic Coupon Generation, Distribution, Reimbursement and Settlement System including support of the authentication of consumers and support of the point-of-sale processing sessions including the electronic coupon generation, distribution and reimbursement processes taking place at the point-of-sale site , supporting the follow-on manufacturer/merchandiser settlement process and all subsequent monitoring, auditing and analytical procedures using transaction processing history.

2. I claim as my invention the use of a central nationally available custom Internet site to support all interactions with the Electronic Coupon Generation, Distribution, Reimbursement and Settlement System by consumer members and their representatives, merchandisers and their designated administrators, manufacturers and their designated administrators and other users requesting information; supporting consumer membership setup and administration; manufacturer setup, product master maintenance and electronic coupon template administration; merchandiser point-of-sale site administration; consumer coupon review and shopping trip planning activities; and communications/customer service support involving all parties.

3. I claim as my invention the integration and use of access controls, security controls, monitoring processes and audit procedures to protect sensitive data and prevent unauthorized processing and other measures that are needed to be compliant with strict data security standards required by the Payment Card Industry (PCI) Data Security Standard for processing sensitive consumer, manufacturer and merchandiser information used for authentication and transaction processing purposes by the Electronic Coupon Generation, Distribution, Reimbursement and Settlement System.
